(19) United States
(12) Patent Application Publication
(10) Pub. No.: US 2012/0203749 A1
(43) Pub. Date: Aug. 9, 2012

(54) METHOD AND SYSTEM FOR PROPOSAL DEVELOPMENT AND MANAGEMENT

(75) Inventor: Bredt Donald MARTIN, Stevenson Ranch, CA (US)

(73) Assignee: BLACK DOG TECHNOLOGY LLC, Las Vegas, NV (US)

(21) Appl. No.: 13/366,738

(22) Filed: Feb. 6, 2012

Related U.S. Application Data
(60) Provisional application No. 61/440,212, filed on Feb. 7, 2011.

(51) Int. Cl. G06F 17/30

(52) U.S. Cl. 707/705; 707/E17.005

(57) ABSTRACT

A present invention for integrated proposal development and management which provides for improved workflow and efficiency in the development of, and improved accuracy and consistency in, offering or proposal documents for new business. Typical such methods and systems in execution require significant manual labor, multiple non-integrated processes and software programs, and are subject to considerable human error. The present invention provides for a capability of an integrated system which enables the proposal development process to be more efficient, by network integrating the proposal management and document development aspects together or alternately, by integrating the proposal management and document development aspects on a single software platform or computer network, and automating using software programs many of the required tasks and workflows that have previously been performed manually.

### CROSS REFERENCE TO RELATED APPLICATIONS

This patent application claims the benefit of the filing date of U.S. Provisional Patent Application Ser. No. 61/440,212, filed 7 Feb. 2011 and entitled “METHOD AND SYSTEM FOR PROPOSAL DEVELOPMENT AND MANAGEMENT,” the entire contents of which are hereby expressly incorporated by reference.

### FIELD OF THE INVENTION

The present invention relates to methods and systems for proposal development and management, and, more particularly, to network integrated methods and systems for proposal development and management. The invention further relates to databases for storing proposal data sets and document libraries for storing proposal documents, both of which are components of such network integrated systems.

### BACKGROUND OF THE INVENTION

Having an improved method and system for proposal development and management, which integrates multiple proposal datasets into a proposal database, and which provides for selectably processing one proposal data set in the database together with another proposal data set in the database resulting in a processed data set which is a cross-reference of the first proposal data set in the database to the second proposal data set in the database, and also provides for selectably processing proposal documents in the document library together with at least one proposal data set in the database resulting in at least one processed proposal document, is highly desirable.

This invention relates to a network integrated method and system for proposal development and management. It is in particular concerned with a network integrated method and system for use in conjunction with a database which contains proposal data sets. More particularly, the invention relates to a network integrated method and system for proposal development and management whereby the proposal management and document development aspects are integrated together, thereby automating using a suite of methods and software programs many of the required tasks and workflows that have previously been performed manually.

One prior method for proposal development and management requires that multiple proposal datasets are kept on multiple electronic spreadsheet databases, none of which are integrated together. Often, data sets on these diverse electronic spreadsheets become unsynchronized with each other, thus resulting in the inability to determine their configuration baseline. Loss of the configuration baseline of the proposal data sets manifests itself in proposal documents which are not integrated together, and which also may not be compliant with the proposal instructions. These prior methods require skilled personnel to keep the proposal data sets current and are very labor-intensive.

Another of the prior techniques requires that the cross-reference matrix of one proposal data set to another is performed manually, which induces human error into the process. Further, this manual technique requires that the reverse cross-reference of the data sets also be performed manually, which further induces human error into the process.

Yet another of the prior techniques requires that certain updates to proposal documents from proposal data sets be performed manually, which is also an extremely labor-intensive and time-consuming process.

Accordingly, there is a need in the industry for a network integrated method and system which streamlines proposal management and document development processes by automating using a suite of methods and software programs many of the required tasks and workflows that have previously been performed manually.

### SUMMARY OF THE INVENTION

By this invention there is provided an improved network integrated method and system for proposal development and management.

In one embodiment, the present invention comprises in general the following: a database for storing at least a first proposal data set and a second proposal data set; a document library for storing at least one proposal document; a user interface; a software program; and a computer network linking the database, the document library, the user interface, and the software program together. The software program has a first aspect for selectably processing a first proposal data set in the database together with a second proposal data set in the database resulting in at least one processed data set which is a cross-reference of the first proposal data set in the database to the second proposal data set in the database. The software program also has a second aspect for selectably processing the at least one proposal document in the document library together with at least one proposal data set in the database resulting in at least one processed proposal document.

In a preferred embodiment, the present invention is hosted on Microsoft®'s SharePoint® system, and the like, so that the database, the document library, the user interface, and the software program are integrated together on a single program platform. In a preferred embodiment, the present invention is intended to be used by the entire proposal team, including proposal and volume managers, writers, reviewers, and other proposal support personnel such as coordinators, graphic artists and desktop publishers. Accordingly, one aspect of the present invention is role-based security.

In a preferred embodiment, the present invention's overarching purpose is to make the “mechanics” (i.e. the “green” compliance) part of the proposal development process more efficient, thereby freeing up more of the proposal team's time to spend on the convincing and compelling (i.e. “blue” and winning) effort. In a preferred embodiment, this efficiency is accomplished by, inter alia: integrating the proposal management and document development aspects on a single platform, automating using a suite of methods and software programs many of the required tasks and workflows that have previously been performed manually.

Accordingly, in a preferred embodiment, many of the present invention's features/utilities may be selectably executed across multiple documents by a single process action. In a preferred embodiment, the present invention may be installed on in-house servers or accessed via https://encrypted protocol on a hosted SharePoint® server and the like. In one embodiment, it may be installed stand-alone on machines running the Windows® 7 operating system and SharePoint®, and the like.

### BRIEF DESCRIPTION OF THE DRAWINGS

The objects, advantages and features of this invention will become more apparent from a consideration of the following detailed descriptions and the drawings, in which:

FIG. 1 is a simplified block diagram of one embodiment of the present invention.

FIG. 2 is a screen shot of a preferred embodiment of the role-based security feature,

FIG. 3 is a screen shot of one embodiment of the user interface,

FIG. 4 is a screen shot of a preferred embodiment of the user interface,

FIG. 5 is a screen shot of a preferred embodiment of one processed data set which is a representation of a cross-reference of a first proposal data set in the database to a second proposal data set in the database,

FIG. 6 is a screen shot of one embodiment of a reverse cross-reference of one proposal data set to another,

FIG. 7 is a screen shot of a preferred embodiment of selectably processing the at least one proposal document in the document library together with at least one proposal data set in the database,

FIG. 8 is a screen shot of one embodiment of selectably processing one proposal data set in the database together with another proposal data set in the database resulting in a processed data set which is a cross-reference of the first proposal data set in the database to the second proposal data set in the database,

FIG. 9 is a screen shot of a preferred embodiment of the document library,

FIG. 10 is a screen shot of a preferred embodiment of a processed proposal document, and

FIG. 11 is a screen shot of one embodiment of a database which contains multiple proposal data sets.

### DETAILED DESCRIPTION

By this invention there is provided an improved method and system for proposal development and management. In the following description, reference is made to accompanying FIGURES which form a part hereof, and which are shown, by way of illustration, several embodiments of the present invention. It is understood that other embodiments may be utilized and structure changes may be made without departing from the scope of the present invention.

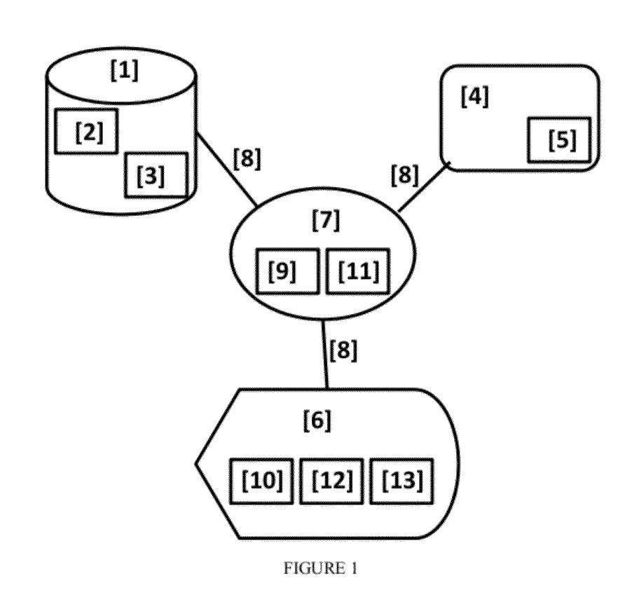

FIG. 1 is a simplified block diagram of one embodiment of the present invention, comprising in general the following: a database [1] for storing at least a first proposal data set [2] and a second proposal data set [3]; a document library [4] for storing at least one proposal document [5]; a user interface [6]; a software program [7]; and a computer network [8] linking the database [1], the document library [4], the user interface [6], and the software program [7] together. The software program [7] has a first aspect [9] for selectably processing a first proposal data set [2] in the database [1] together with a second proposal data set [3] in the database [1] resulting in at least one processed data set [10] which is a cross-reference of the first proposal data set [2] in the database [1] to the second proposal data set [3] in the database [1]. The software program [7] also has a second aspect [11] for selectably processing the at least one proposal document [5] in the document library [4] together with at least a first proposal data set [2] in the database [1] resulting in at least one processed proposal document [12]. The user interface [6] has a role-based security feature [13] which permits, or restricts, users from accessing features of the invention. In one embodiment, the computer network [8] is a local area network (LAN) and the like. In another embodiment, the computer network [8] is the internet. In yet another embodiment, the computer network [8] is a wireless network. In still yet another embodiment, the computer network [8] is a wide-area network (WAN).

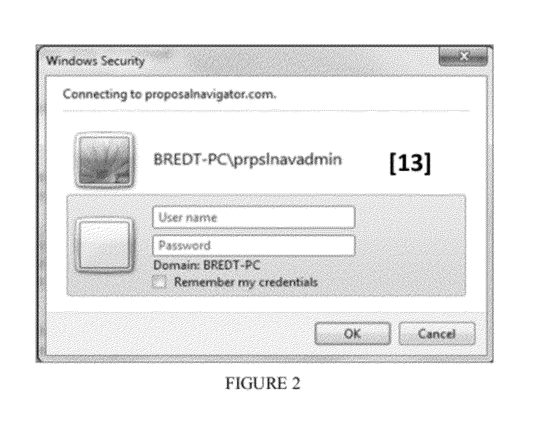

FIG. 2 is a screen shot of a preferred embodiment of the role-based security feature [13], adapted for use for the invention within the Microsoft® SharePoint® framework and the like. In one embodiment, the security feature [13] is custom developed as part of the software program [7].

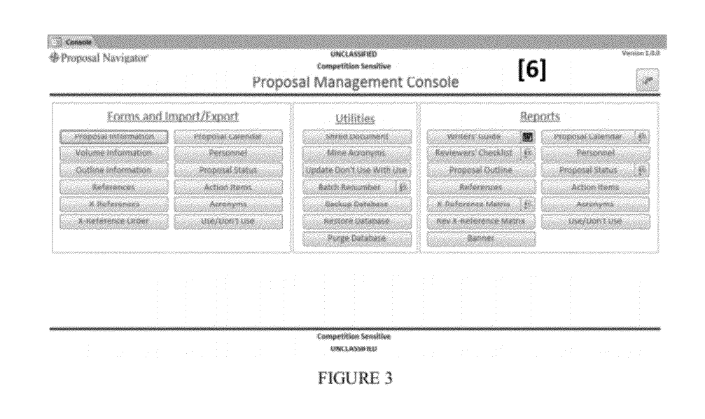

FIG. 3 is a screen shot of one embodiment of the user interface [6]. In one embodiment, the user interface [6] comprises a menu of the invention's features from which the user may selectably execute. In one embodiment, the user interface [6] is developed within the Microsoft® Access® framework. In another embodiment, the user interface [6] is a mobile device.

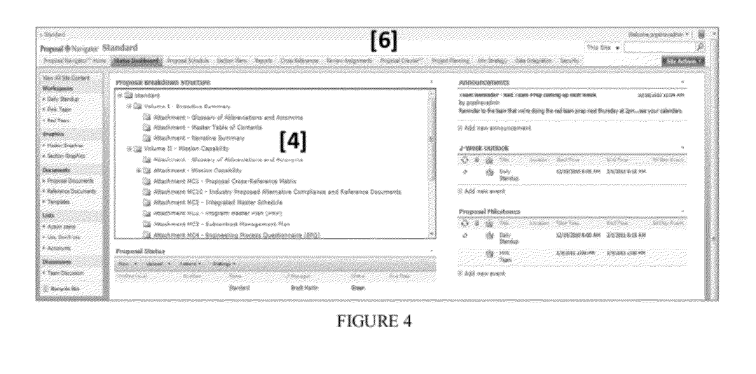

FIG. 4 is a screen shot of a preferred embodiment of the user interface [6]. In a preferred embodiment, the user interface [6] is integrated with the document library [4].

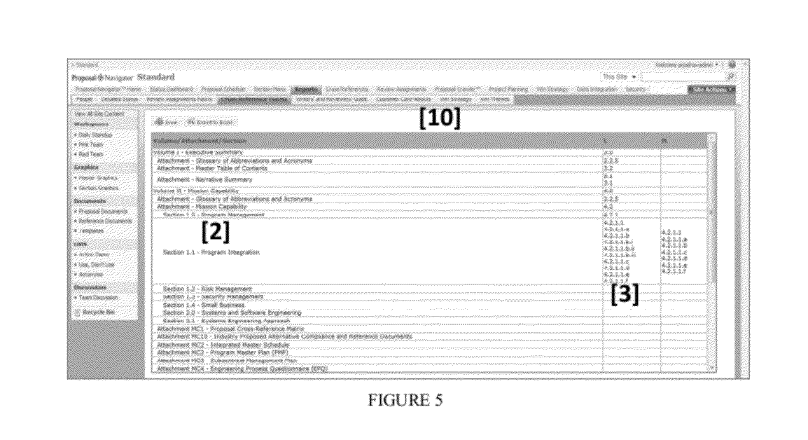

FIG. 5 is a screen shot of a preferred embodiment of a processed data set [10] which is a representation of a cross-reference of a first proposal data set [2] in the database [1] to a second proposal data set [3] in the database [1].

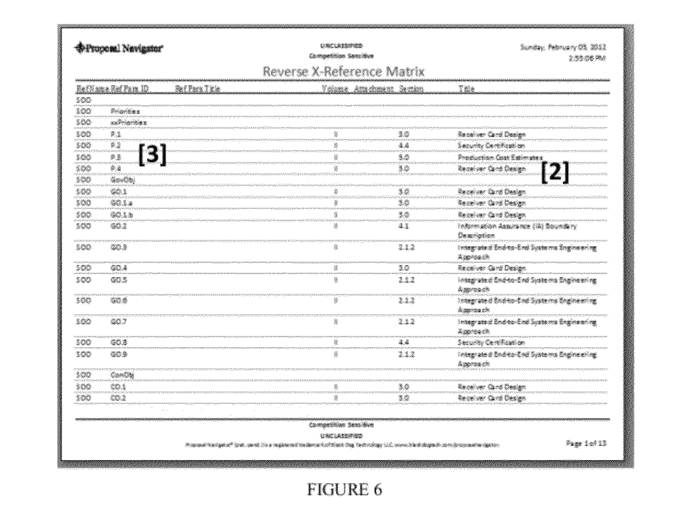

FIG. 6 is a screen shot of one embodiment of a reverse cross-reference of a second proposal data set [3] in the database [1] to a first proposal data set [2] in the database [1].

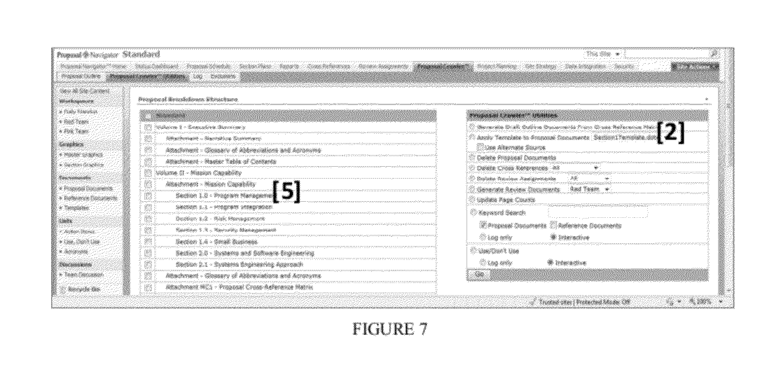

FIG. 7 is a screen shot of a preferred embodiment of selectably processing the at least one proposal document [5] in the document library [4] together with at least a first proposal data set [2] in the database [1].

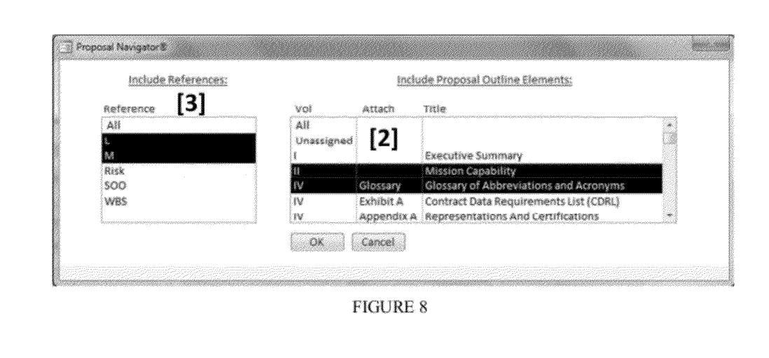

FIG. 8 is a screen shot of one embodiment of selectably processing a first proposal data set [2] in the database [1] together with a second proposal data set [3] in the database [1]. In one embodiment of selectably processing a first proposal data set [2] in the database [1] together with a second proposal data set [3] in the database [1], the resulting processed data set [10] is a cross-reference matrix. In another embodiment of selectably processing a first proposal data set [2] in the database [1] together with a second proposal data set [3] in the database [1], the resulting processed data set [10] is a reverse cross-reference matrix. In yet another embodiment of selectably processing a first proposal data set [2] in the database [1] together with a second proposal data set [3] in the database [1], the resulting processed data set [10] is an annotated proposal outline.

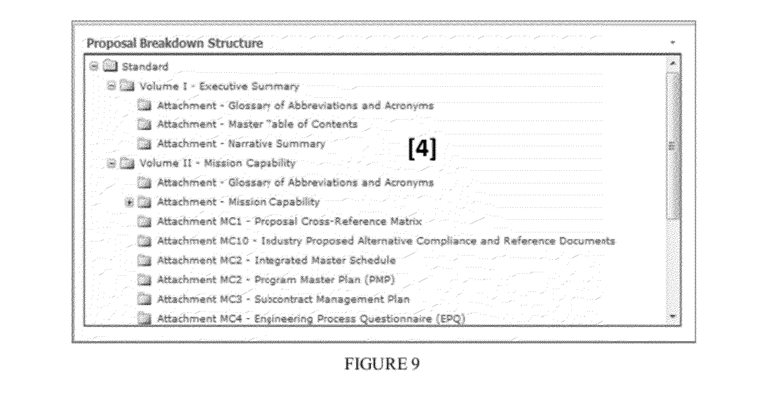

FIG. 9 is a screen shot of a preferred embodiment of the document library [4]. In a preferred embodiment, the document library [4] is hosted on Microsoft® SharePoint®. In one embodiment, the document library [4] is hosted on a networked computer server. In one embodiment, the document library [4] is represented by a hierarchical structure which aligns with the proposal outline.

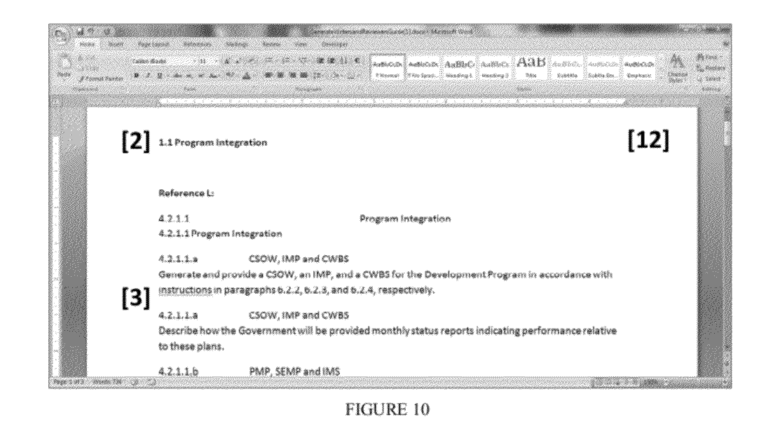

FIG. 10 is a screen shot of a preferred embodiment of a processed proposal document [12] which includes data from a first dataset [2] in the database [1] and also data from a second dataset [3] in the database [1]. In a preferred embodiment, the processed proposal document [12] is in native Microsoft® Office Word format. In one embodiment, the processed proposal document [12] is in native Microsoft® Office Excel format

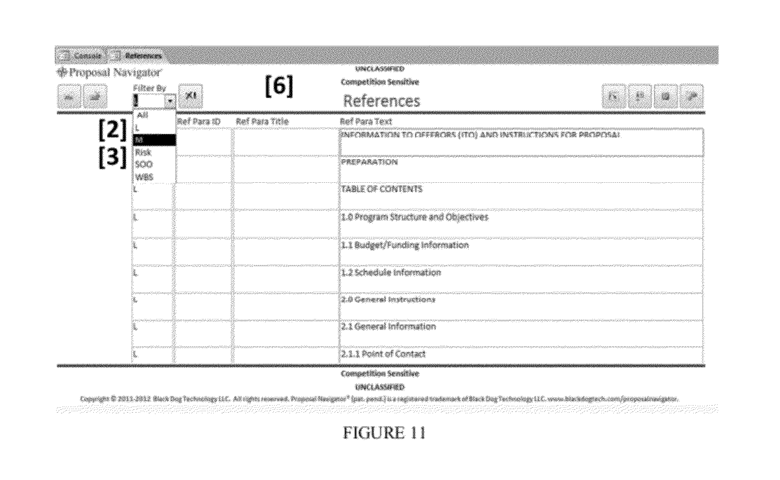

FIG. 11 is a screen shot of one embodiment of a database [1] which contains at least a first proposal data set [2] and a second proposal data set [3]. In one embodiment, a pull-down menu on the user interface [6] provides access to a first proposal data set [2] and a second proposal data set [3].

I claim:

1. A network integrated system for proposal development and management comprising:
a database, the database being for storing at least a first proposal data set and a second proposal data set;
a document library, the document library being for storing at least one proposal document;
a computer network;
a user interface;
a software program, the software program having a first aspect, the first aspect being for selectably processing the first proposal data set in the database together with the second proposal data set in the database resulting in at least one processed data set, the at least one processed data set being a cross-reference of the first proposal data set in the database to the second proposal data set in the database, and the software program having a second aspect, the second aspect being for selectably processing the at least one proposal document in the document library together with at least the first proposal data set in the database resulting in at least one processed proposal document, wherein the database, the document library, the user interface, and the software program are linked via the computer network.
